(19) United States
(12) Patent Application Publication
(10) Pub. No.: US 2022/0249881 A1
(43) Pub. Date: Aug. 11, 2022

(54) FACE MASK

(71) Applicant: Yasir Altahir, Kitchener (CA)

(72) Inventor: Yasir Altahir, Kitchener (CA)

(21) Appl. No.: 17/170,974

(22) Filed: Feb. 9, 2021

(51) Int. Cl. A62B 18/02; A41D 13/11; A62B 18/10

(52) U.S. Cl. CPC A62B 18/025; A62B 18/10; A41D 13/11

(57) ABSTRACT

A face mask configured to be worn by a user covering the mouth and nose thereof wherein the face mask inhibits inhalation of airborne pathogens and further directs exhaled air outside of the face mask. The present invention includes a membrane member that covers the nose and mouth area of the face of the wearer. A dividing membrane is present wherein the dividing membrane divides the cavity or void between the membrane member and the face into an upper portion and a lower portion. The nose is disposed in the upper portion and the mouth is disposed in the lower portion. An exhalation tube is present in the lower portion and includes a mouthpiece for a user to engage therewith. A user will inhale utilizing their nose and exhale with their mouth through the exhalation tube wherein the second end of the tube expels air outside of the face mask.

### FIELD OF THE INVENTION

The present invention relates generally protective hygienic devices, more specifically but not by way of limitation, a face mask that is worn by a user so as to filter inhalation air so as to remove contaminants such as but not limited to viruses wherein the present invention provides a technique to exhale air so as to not be introduced into the cavity between the mask and the wearer's face.

### BACKGROUND

Face masks have been worn in areas such as but not limited to clean rooms and certain areas of hospitals for decades. These facemasks are configured to both provide protection for a wearer as well as provide protection for either other individuals in a particular area or to protect the area itself. Alternate types of facemasks are utilized by individuals that are working in environments having volatile hazardous chemicals present therein. Other masks such as but not limited to N95 masks are utilized in environments that may potentially have airborne pathogens or other disease causing viruses wherein these types of masks provide sufficient filtration so as to be able to inhibit the inhalation thereof by a wearer of the aforementioned type of masks.

One problem with hygienic masks such as but not limited to N95 masks is their inability effectively exhaust air from the cavity thereof when a user exhales. As N95 masks and the like heavily filter the air, their very design creates a negative side effect for airflow. While airflow is somewhat restrictive for inhalation, that is typically not an issue for most wearers of these types of masks. The membrane size of the N95 mask traps a large portion of the exhaled air between the mask and the face of the wearer in a cavity formed by the mask which is sealed on the face of the wearer. This trapped exhaled air has a high percentage of carbon dioxide and is not beneficial for a user to inhale. Inevitably, the wearer of these conventional masks will inhale the higher percentage carbon dioxide air, which can lead to feelings of nausea or cause the wearer to be short of breath.

Accordingly, there is a need for a facemask that can provide effective filtration of all airborne pathogens and further provide a technique to ensure exhaled air is removed from the cavity between the facemask and the wearer so as to inhibit a wearer from inhaling air that has a higher than normal percentage of carbon dioxide.

### SUMMARY OF THE INVENTION

It is the object of the present invention to provide a facemask that is configured to inhibit inhalation of airborne pathogens wherein the present invention includes a membrane member operable to filter inhaled air.

Another object of the present invention is to provide a facemask operable to inhibit inhalation of airborne pathogens and further inhibits accumulation of exhaled air between the membrane member and the face of the wearer wherein the present invention includes a dividing membrane that separates the cavity between the face of the wearer into an upper portion and a lower portion.

A further object of the present invention is to provide a facemask that is configured to inhibit inhalation of airborne pathogens wherein the upper portion envelops the nose and nose area of the wearer.

Still another object of the present invention is to provide a facemask operable to inhibit inhalation of airborne pathogens and further inhibits accumulation of exhaled air between the membrane member and the face of the wearer wherein the lower portion envelops the mouth area of the wearer.

An additional object of the present invention is to provide a facemask that is configured to inhibit inhalation of airborne pathogens wherein a exhalation tube is present in the lower portion of the cavity of the facemask.

Yet a further object of the present invention is to provide a facemask operable to inhibit inhalation of airborne pathogens and further inhibits accumulation of exhaled air between the membrane member and the face of the wearer wherein the exhalation tube further includes a one-way valve.

Another object of the present invention is to provide a facemask that is configured to inhibit inhalation of airborne pathogens wherein the exhalation tube includes a N95 or similar filter and is further oriented to discharge exhaled air outside of the cavity present between the facemask and the wearer.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a rear diagrammatic view of the present invention; and

FIG. 2 is a side diagrammatic view of the present invention.

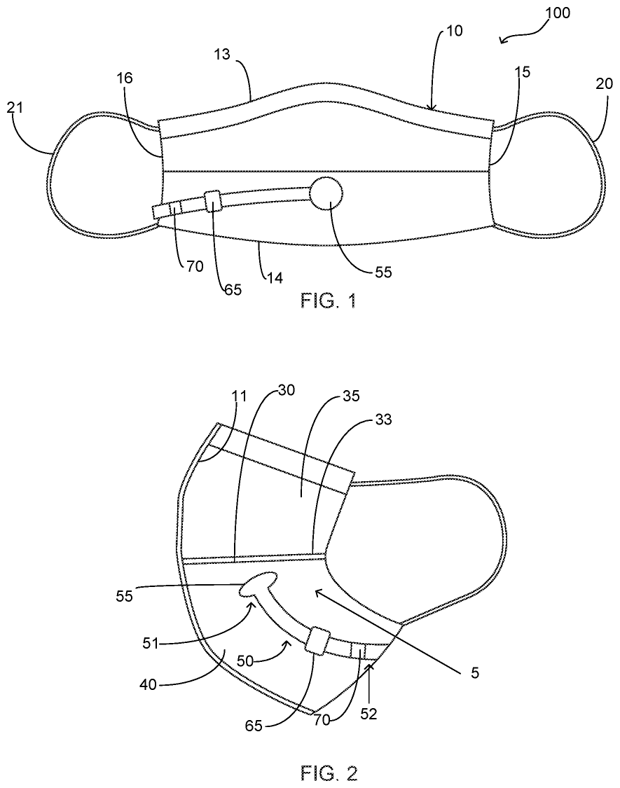

### DETAILED DESCRIPTION

Referring now to the drawings submitted herewith, wherein various elements depicted therein are not necessarily drawn to scale and wherein through the views and figures like elements are referenced with identical reference numerals, there is illustrated a face mask 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the face mask 100 includes a membrane member 10. The membrane member 10 includes a body 12 wherein the body 12 includes an upper edge 13, a lower edge 14 and opposing lateral edges 15,16 defining the shape thereof. The body 12 is somewhat rectangular in shape and of suitable size to partially cover a face of a wearer. It should be understood within the scope of the present invention that the body 12 of the present invention could be provided in alternate shapes and sizes so as to properly fit a variety of wearers. The membrane member 10 is manufactured from a suitable material that is operable to filter airborne pathogens so as to inhibit propagating through the membrane member 10. Materials such as but not limited to N95 are utilized to achieve the desired filtration capabilities of the face mask 100. While not particularly illustrated it is contemplated within the scope of the present invention that the body 12 could have a sealing element such as but not limited to silicon disposed on the upper edge 13, lower edge 14 and opposing lateral edges 15,16.

A pair of securing straps 20,21 are secured to the opposing lateral edges 16. The securing straps 20,21 in a preferred embodiment are manufactured from an elastic material and are operable to be stretched over the ears of a wearer in order to secure the face mask 100. It is contemplated within the scope of the present invention that the body 12 could be releasably secure to the face of a wearer utilizing alternate suitable elements in place of and/or in conjunction with the securing straps 20,21.

A dividing membrane 30 is secured to the inner surface 11 of the body 12 and is operable to divide the cavity 5 into an upper portion 35 and lower portion 40. The dividing membrane 30 extends from the inner surface 11 of the body 12 to the face of the wearer wherein the rear edge 33 will engage the face of a wearer on an area above the lip and laterally in both directions therefrom extending to the opposing lateral edges 15,16. The dividing membrane 30 is manufactured from a flexible non-porous material such as but not limited to plastic and functions to provide atmospheric division of the upper portion 35 and lower portion 40. A user will inhale air through their nose wherein incoming air will be filtered into the upper portion 35 and received by the wearer. Exhaled air will be propagated through the exhalation tube 50 in the lower portion 40 as will be further discussed herein. The dividing membrane 30 ensures that a wearer of the face mask 100 will not re-inhale air that has been expelled by the user by both utilizing the dividing membrane 30 and the exhalation tube 50.

The exhalation tube 50 is secured within the lower portion 40 of the face mask 100. The exhalation tube 50 includes first end 51 and second end 52 and is a hollow tube being manufactured from a suitable flexible material such as but not limited to plastic. The exhalation tube 50 includes a mouthpiece 55 located at the first end 51. The mouthpiece 55 is configured to be engaged by a wearer's mouth and it is contemplated within the scope of the present invention that the mouthpiece could be provided in alternate shapes and sizes.

A valve 65 is present along the exhalation tube 50. The valve 65 is downstream of the mouthpiece and is a one-way valve that provides airflow control for air exiting the exhalation tube 50 and inhibits air from being inhaled through the exhalation tube 50. This provides protection for a wearer of the face mask 100 so as to avoid potentially inhaling air that has not been filtered. It should be understood within the scope of the present invention that the valve 65 could be provided in various configurations in order to achieve the desired objective discussed herein.

A filter 70 is integrally mounted into the exhalation tube 50. The filter 70 is operable to provide filtration of the exhaled air passing through the exhalation tube 50. To meet both potential regulatory requirements as well as provide an improved hygienic performance of the face mask 100 the filter 70 has been secured into the exhalation tube 50 utilizing suitable durable techniques. The filter 70 can be manufactured from N95 material or some equivalent thereof so as to ensure filtration of airborne pathogens from the exhaled air propagating from the exhalation tube 50. It is contemplated within the scope of the present invention that the filter 70 is replaceable so as to extend the overall usable lifetime of the face mask 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A face mask operable to provide hygienic benefits for a wearer wherein the face mask comprises:
a membrane member, said membrane member having a body, said body of said membrane member having an upper edge and a lower edge, said membrane member having opposing lateral edges, said membrane member being of suitable size to cover a nose and mouth of the wearer of the face mask, said membrane member configured to form a cavity between the membrane member and a face of the wearer;
a dividing membrane, said dividing membrane extending across the body of said membrane member intermediate said opposing lateral edges, said dividing membrane being perpendicular to said membrane member, said dividing membrane extending towards the face of the wearer and engaging therewith, said dividing membrane operable to separate the cavity into an upper portion and a lower portion; and
an exhalation tube, said exhalation tube being disposed in said lower portion of said cavity, said exhalation tube having a first end and a second end, said exhalation tube operable to discharge exhaled air outside of said lower portion.

2. The face mask operable to provide hygienic benefits as recited in claim 1, wherein said exhalation tube further includes a one way valve configured to permit airflow from the first end to the second end.

3. The face mask operable to provide hygienic benefits as recited in claim 2, wherein said dividing membrane further includes a rear edge, said rear edge of said dividing membrane configured to engage a portion of the face of the wearer underneath a nose of the wearer.

4. The face mask operable to provide hygienic benefits as recited in claim 3, wherein the dividing membrane atmospherically divides the upper portion and lower portion of the cavity.

5. The face mask operable to provide hygienic benefits as recited in claim 4, wherein said first end of said exhalation tube includes a mouthpiece, said mouthpiece provided to operably insert into a mouth of the wearer for exhaling air thereinto.

6. The face mask operable to provide hygienic benefits as recited in claim 5, wherein said exhalation tube further includes filter, said filter being downstream of said one-way valve, said filter operable to filter pathogens from exhaled air passing through said exhalation tube.

7. The face mask operable to provide hygienic benefits as recited in claim 6, wherein said body further includes securing straps, said securing straps being operably coupled to the opposing lateral edges of said body.

8. The face mask operable to provide hygienic benefits as recited in claim 7, wherein said filter is a N95 filter.

9. A face mask configured to be worn by a user on a face so as to cover a nose and mouth in order to inhibit inhalation of airborne pathogens wherein the face mask comprises:
a membrane member, said membrane member having a body, said body of said membrane member having an upper edge and a lower edge, said membrane member having opposing lateral edges, said membrane member being of suitable size to cover a nose and mouth of the wearer of the face mask, said membrane member configured to form a cavity between the membrane member and a face of the wearer;
a dividing membrane, said dividing membrane extending across the body of said membrane member intermediate said opposing lateral edges, said dividing membrane being perpendicular to said membrane member, said dividing membrane extending towards the face of the wearer and engaging therewith, said dividing membrane operable to separate the cavity into an upper portion and a lower portion, said upper portion and said lower portion being atmospherically separated, said upper portion of said cavity having the nose of the wearer disposed therein, said lower portion of said cavity having the mouth of the wearer disposed therein; and
an exhalation tube, said exhalation tube being disposed in said lower portion of said cavity, said exhalation tube having a first end and a second end, said first end being proximate the mouth of the user, said exhalation tube further including a one-way valve, said one-way valve being intermediate said first end and said second end, said exhalation tube operable to discharge exhaled air outside of said lower portion.

10. The face mask configured to be worn by a user on a face so as to cover a nose and mouth in order to inhibit inhalation of airborne pathogens as recited in claim 9, wherein said exhalation tube further includes filter, said filter being proximate said second end of said exhalation tube, said filter operable to filter pathogens from exhaled air passing through said exhalation tube.

11. The face mask configured to be worn by a user on a face so as to cover a nose and mouth in order to inhibit inhalation of airborne pathogens as recited in claim 10, wherein said first end of said exhalation tube includes a mouthpiece, said mouthpiece provided to operably insert into the mouth of the wearer for exhaling air thereinto.

12. The face mask configured to be worn by a user on a face so as to cover a nose and mouth in order to inhibit inhalation of airborne pathogens as recited in claim 11, wherein said dividing membrane further includes a rear edge, said rear edge of said dividing membrane configured to engage a portion of the face of the wearer above an upper lip of the wearer and laterally along towards opposing cheeks.

13. The face mask configured to be worn by a user on a face so as to cover a nose and mouth in order to inhibit inhalation of airborne pathogens as recited in claim 12, wherein said body further includes securing straps, said securing straps being operably coupled to the opposing lateral edges of said body.

14. The face mask configured to be worn by a user on a face so as to cover a nose and mouth in order to inhibit inhalation of airborne pathogens as recited in claim 13, wherein said filter is a N95 filter.
